(19) United States
(12) Patent Application Publication
(10) Pub. No.: US 2012/0072347 A1
(43) Pub. Date: Mar. 22, 2012

(54) POLICY-BASED PAYMENT TRANSACTION ROUTING SERVICE FOR CREDIT CARD PAYMENT PROCESSING

(76) Inventor: Anthony Conway, Hong Kong (CN)

(21) Appl. No.: 13/257,889

(22) PCT Filed: Dec. 31, 2009
(86) PCT No.: PCT/IB2009/008020

§ 371 Date: Dec. 1, 2011

(30) Foreign Application Priority Data
Mar. 20, 2009 (US) 61161882

(51) Int. Cl. G06Q 20/40

(52) U.S. Cl. 705/44

(57) ABSTRACT

The present document describes a method, processing device and computer readable media, for routing a credit card payment transaction over a communication network. The method comprises receiving an authorization request for the credit card payment transaction at a payment processor, the authorization request being generated at a merchant terminal of a merchant. The method also comprises: at the payment processor, determining an optimal transaction route for sending the authorization request over the communication network to one of multiple acquirer servers, each one of the multiple acquirer servers being associated to one of multiple acquiring financial institutions of the merchant, the determining being based on payment processing costs associated to routing the authorization request from the merchant terminal to each one of the multiple acquirer servers; the payment processor routing the authorization request to the one of the multiple acquirer servers implementing the optimal transaction route; the payment processor receiving, from the one of the multiple acquirer servers, an authorization response for the authorization request; the payment processor forwarding the authorization response to the merchant terminal; and the merchant terminal displaying the authorization response forwarded by the payment processor, to thereby notify a user of the authorization response.

### CROSS-REFERENCE TO RELATED APPLICATIONS

This application claims priority under 35USC§119(e) of U.S. provisional patent application 60/161,882, filed Mar. 20, 2008 and entitled “A POLICY-BASED PAYMENT TRANSACTION ROUTING SERVICE FOR CREDIT CARD PAYMENT PROCESSING”, the specification of which is hereby incorporated by reference.

### TECHNICAL FIELD

This description relates to credit card payment processing and more particularly to the routing involved in the processing of credit card transactions.

### BACKGROUND

In the credit card payment industry, merchants typically connect to only one or a few pre-chosen acquiring banks for credit card transaction processing. As a result, they typically pay a high transaction fee to their acquiring banks for the respective payment services rendered by each of those banks. A payment service level is typically limited to using only one service provider (i.e. the acquiring bank in such a case). A merchant thus establishes servicing relationships with each one of the acquiring banks with which the merchant has an account. This process is neither practical nor cost effective to the merchant in terms of both technological and economical considerations.

There is therefore a need for improved payment transaction routing solutions for credit card payment processing.

### SUMMARY

The present disclosure provides a processing device, a method and computer readable media with instructions for implementing a credit card payment transaction routing that overcomes or at least mitigates one or more disadvantages of known prior art, or at least provides a useful alternative thereto.

According to an embodiment, there is provided a method for routing a credit card payment transaction over a communication network. The method comprises receiving an authorization request for the credit card payment transaction at a payment processor, the authorization request being generated at a merchant terminal of a merchant. The method also comprises: at the payment processor, determining an optimal transaction route for sending the authorization request over the communication network to one of multiple acquirer servers, each one of the multiple acquirer servers being associated to one of multiple acquiring financial institutions of the merchant, the determining being based on payment processing costs associated to routing the authorization request from the merchant terminal to each one of the multiple acquirer servers; the payment processor routing the authorization request to the one of the multiple acquirer servers implementing the optimal transaction route; the payment processor receiving, from the one of the multiple acquirer servers, an authorization response for the authorization request; the payment processor forwarding the authorization response to the merchant terminal; and the merchant terminal displaying the authorization response forwarded by the payment processor, to thereby notify a user of the authorization response.

According to another embodiment, there is provided a processing device for routing a credit card payment transaction between a merchant terminal at a merchant, and acquirer servers each associated to one of multiple acquiring financial institutions of the merchant. The processing device comprises: a processor in communication with: the merchant terminal and each one of the acquirer servers of the multiple acquiring financial institutions; and a memory device operatively coupled to the processor. The memory device stores instructions for implementing the processor to: receive an authorization request for the credit card payment transaction from the merchant terminal; determine an optimal transaction route for sending the authorization request to one of the acquirer servers, based on payment processing costs associated to routing the authorization request from the merchant terminal to each one of the acquirer servers; route the authorization request to the one of the acquirer servers to implement the optimal transaction route; receive, from the one of the acquirer servers, an authorization response for the authorization request; and forward the authorization response to the merchant terminal, to thereby complete the credit card payment transaction using the optimal transaction route.

According to yet another embodiment, there is provided a computer readable media storing coding for implementing a routing of a credit card payment transaction in a processing device. The processing device has an access to a communication network and the coding implements the processing device to: receive, from a merchant, an authorization request for the credit card payment transaction; determine an optimal transaction route for sending the authorization request over the communication network, to one of multiple acquirer servers, each one of the multiple acquirer servers being associated to one of multiple acquiring financial institutions of the merchant, the determining being based on payment processing costs associated to routing the authorization request from the merchant to each one of the multiple acquirer servers; route the authorization request to the one of the multiple acquirer servers implementing the optimal transaction route; receive, from the one of the multiple acquirer servers, an authorization response for the authorization request; and display the authorization response at the merchant, to thereby notify the merchant of the authorization response.

In the present disclosure, the following terms are intended to refer to the following respective definitions:

“Acquirer”: The acquiring bank or financial institution of a merchant where the merchant deposits revenue (also referred to as monetary acquisition) from the payment transaction. In other words, it is the bank which administers the acquisition made by the payment transaction. The “acquirer” has an “acquirer server”, which itself can include a plurality of servers.

“Issuer”: The issuing bank or financial institution which issued the credit card involved in the payment transaction. In other words, it is the organization which issued the credit card to the buying customer for making payment transactions with merchants. The issuer provides transaction authorizations for transaction requests based on the customer's credential for example.

“Policy-Based Payment. Transaction Routing (PPTR)”: the routing of payment transaction requests to an acquirer based on predefined policies which will be described in greater detail herein below.

“Aggregator”: A centralized payment transaction processing concentrator (also referred to as center) which connects multiple merchants to multiple acquirers using corresponding payment channel integration technologies. The aggregator is also referred to as a router since one of its functions is to route payment transactions requests from any one of the merchants to a given acquirer.

“On-Us Transaction”: A credit card payment transaction in which the acquirer and the issuer are one and only organization.

“Static Payment Routing”: A pre-defined static routing path (also referred to as routing rule) which specifies the routing of a transaction payment request based on input routing information such as merchant identification, credit card number and/or merchant profile.

“Dynamic Payment Routing”: A real-time generated path (also referred to as routing rule) which in addition to specifying the routing of a transaction payment request based on input routing information such as merchant identification, card number and/or merchant profile, is dynamically (i.e. in real-time) adjusted according to a service status of a payment processor involved in the transaction.

“Institution Identification Number (IIN)”: Typical credit card numbering scheme which uses a common number mechanism based on ISO 7812 standards. IIN refers to the first six (6) digits of a credit card number, and may be also referred to as a Bank Identification Number (BIN). This sequence of numbers identifies the issuing financial institution (e.g. issuer) that issued the card to the card holder (i.e. buying customer of a transaction).

“Bank Identification Number (BIN)”: A six (6) digit number assigned by a given financial institution for example to identify a member (e.g. payment processor of an issuer and/or an acquirer); the member being responsible for either one of the issuing, authorization, clearing, and settlement processing of a payment transaction. In one embodiment, the issuer assigns a set of six digits as the first six digits of the card number issued to the card holder.

“Default Payment Processor”: Similar to the term “default gateway” known in computer networking technology, the default payment processor refers to a one of: a predefined acquirer and a predefined other payment aggregator to which a payment request is to be routed from a payment aggregator. Such default payment processor is used for example whenever no other specified static routes are provided, and/or whenever no real-time dynamic routes are generated. Note that payment processor is also referred to as a payment processing entity.

“Merchant Discount Rate (MDR)”: Merchant discount rate comprises a number of dues, fees, assessments, network charges and mark-ups which accumulate to a given fee representative of such MDRs which merchants are required to pay to the acquirer for accepting credit cards and proceeding with the processing merchant's requests for credit card payment transactions.

“Next Payment Routing Hop”: Next payment routing hop refers to a next payment processing entity to which a payment aggregator passes a payment request. For example, in an embodiment involving a single payment aggregator, a next payment routing hop refers to a payment acquirer that is able to process the payment request sent by the merchant. In another embodiment involving multiple payment aggregators, a next payment routing hop is one of: an acquirer and another payment aggregator which is able to process the payment request.

### BRIEF DESCRIPTION OF THE DRAWINGS

Further features and advantages of the present disclosure will become apparent from the following detailed description, taken in combination with the appended drawings, in which:

FIG. 1 is a block diagram illustrating a credit card payment transaction routing in accordance with the prior art;

FIG. 2 is a block diagram illustrating a credit card payment transaction routing in accordance with an embodiment;

FIG. 3 is a schematic illustration of a payment network topology in accordance with an embodiment;

FIG. 4 is a detailed schematic illustration of the payment aggregator of FIG. 3, with its inputs and outputs, in accordance with an embodiment;

FIG. 5 is a detailed schematic illustration of the payment aggregator of FIG. 3 implemented as a processing device, in accordance with an embodiment;

FIG. 6 is a payment routing table in accordance with an embodiment;

FIG. 7 is a status table in accordance with an embodiment; and

FIG. 8 is a block diagram of a method for routing a credit card payment transaction, in accordance with an embodiment.

It will be noted that throughout the appended drawings, like features are identified by like reference numerals.

### DETAILED DESCRIPTION

The present describes an intelligent Policy-Based Payment Transaction Routing (PPTR) Service for routing credit card payment processing as optimally as possible considering policies involves, associated costs and real-time availability of involves payment processors. Various embodiments will be described, such as a method, corresponding application, computer readable media and a processing device implementing a payment aggregator adapted to capture data, process the data, and route transactions between multiple merchants and multiple acquirers based on such data and a given set of parameters to be satisfied. Optimization on payment processing cost, performance and rapidity based for example, on availabilities and statuses of credit card payment processors, and/or any other dynamic and/or static information will be described. The proposed service can be implemented either at the merchant level (i.e. installed at the merchant's location), and/or at a payment service provider's back office (i.e. in a server installed at a service provider's location, which accessible to multiple merchant terminals using a given networking strategy).

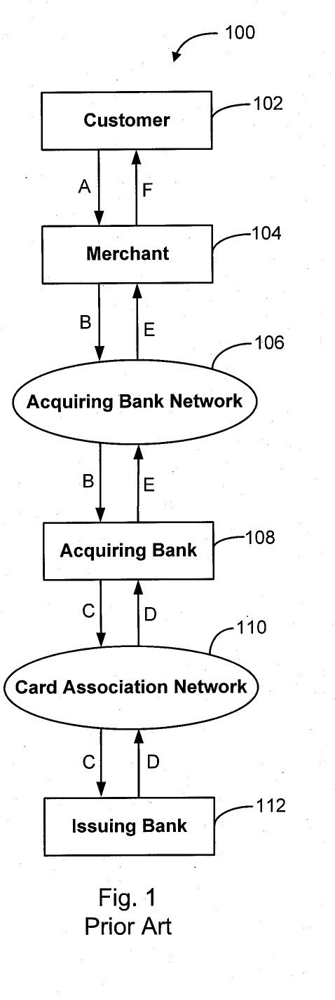

Prior to proceeding with the description of a PPTR in accordance with various embodiments presented herein, a word on a typical prior art transaction routing schemes is provided briefly below with reference to FIG. 1.

A typical credit card payment authorization routing flow 100 in accordance with the prior art proceeds as such:

In (A), a customer 102 initiates a payment process by swiping his/her credit card (card present) or by providing his/her card information (card not-present) to the merchant 104. These two transaction initiations (card present and card not present) refer to respective cases where the customer provides the card at a merchant location and where the customer sends the credit card number to the merchant either by phone or via an online network for example. The merchant issues a payment authorization request.

In (B), the merchant 104 passes the payment authorization request with the card information to the acquiring bank 108, via an acquiring bank network 106. Access to the acquiring bank network 106 is typically provided to the merchant by the same acquiring bank 108.

In (C), once the acquiring bank 108 received the payment authorization request, the acquiring bank 108 passes the payment authorization request to the issuing bank 112 typically via a card association network 110 such as a Proprietary Card Processor Network (e.g. Visa™, MasterCard™, etc.).

In (D), the issuing bank 112 replies to the payment authorization request with an authorization response after verification of the credit card holder's account for allowing the payment. The authorization response is sent back to the acquiring bank 108, also typically via the card association network 110.

In (E), the acquiring bank 108 forwards the authorization response to the merchant 104 via the acquiring bank network 106.

Finally in (F), the merchant 104 is able to respond accordingly to the customer following receipt of the payment authorization response.

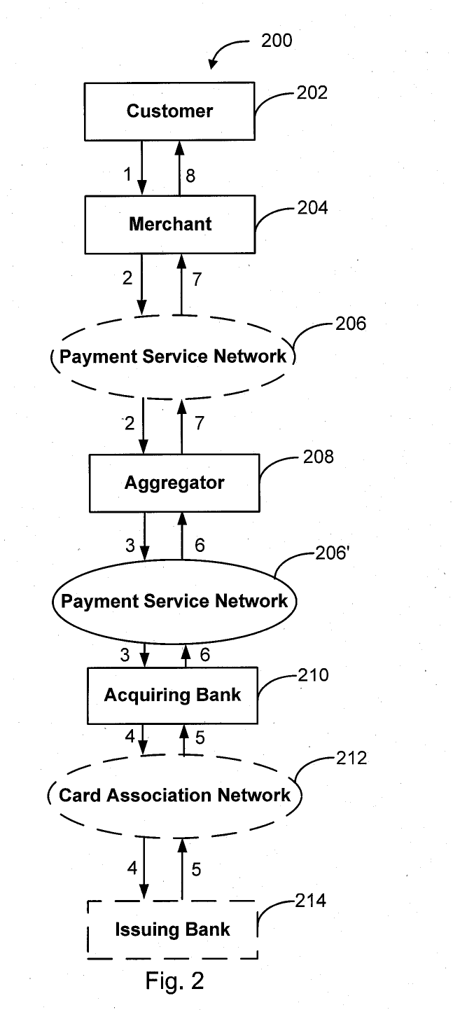

Now in contrast with the above-described prior art routing, FIG. 2 illustrates a credit card payment transaction routing flow 200 in accordance with an embodiment.

In (1), the customer 202 initiates the payment process by swiping his/her credit card (card present) or by providing his/her card information online (card not-present) to the merchant 204, similarly as in the prior art A (refer to FIG. 1). The merchant 204 then generates a payment request.

In (2), the merchant 204 passes the payment request with the card information to the Payment Aggregator 208 optionally via a Payment Service Network 206. It is noted that in one embodiment where the payment aggregator 208 is located remotely from the merchant 204, the payment request is transmitted from the merchant 204 to the payment aggregator 208 via the network 206. In another embodiment (not shown), the payment aggregator 208 is located at the merchant's 204 location, in which case the payment service network 206 may not be required by the merchant 204 to send the request to the payment aggregator 208.

In (3), the Payment Aggregator 208 routes the payment authorization request to a selected acquiring bank 210 (also referred to as a selected acquirer or acquirer server) based on a policy-based payment routing mechanism detailed herein below. A payment service network 206′ similar to the payment service network 206 (or the same) may be used to perform the routing to the selected acquiring bank 210.

In (4), the selected acquiring bank 210 then optionally passes the authorization request to the issuing bank 214 (also referred to as an issuer or issuing server) via a card association network 212 such as a Proprietary Card Processor Network (e.g. Visa™, MasterCard™, etc.). The card association network 212 and the issuing bank 214 are meant to be optional since they are not required when the transaction is an “On-Us” transaction (refer to the definition in the above Summary section).

In (5), the issuing bank 214 replies to the request with an authorization response after checking and verifying the customer's account and potentially allowing or refusing the payment transaction. The authorization response is sent back to the selected acquiring bank 210, again via the card association network 212. This is also optional since not required in On-Us transactions.

In (6), the selected acquiring bank 210 forwards the authorization response to the payment aggregator 208, via the network 206′.

In (7), the payment aggregator 208 then passes the authorization response to the merchant 204 optionally via the network 206 depending on specifically how the payment aggregator 208 is implemented.

In (8), the merchant 204 responds to the customer following receipt of the payment authorization response, as displayed for example on the merchant's terminal. The response may be positive or negative in that the transaction is either allowed or refused depending on the issuing bank's response (or alternatively the acquiring bank in the case of On-Us transactions).

It is noted that the above described routing flow shown FIG. 2 is adaptable to online transactions where a 3D secure (VBV/MSC//Secure) is enabled, in which case a cardholder secure authentication process takes place before a payment authorization routing process starts. In such a case, the Payment Aggregator 208 redirects the cardholder secure authentication process to the corresponding issuing bank 214, based on information the payment aggregator 208 retrieves from a Card Processor's directory service provided via the card association network 212 such as Proprietary Card Processor for their corresponding verification processes (Verified by Visa™ and MasterCard Secure Code™ for example). This enables a direct user authentication interaction with the issuing bank.

To further clarify the flow in the case of an On-Us transaction, it is noted that in such a case, the Payment Aggregator 208 routes the payment request to an selected acquiring bank 210, which is also the issuing bank 214 for the transaction cardholder. Thus it is not necessary to involve the card association network 212; the selected acquiring bank 210 processes the request. For this reason, “On-Us” credit card payment transactions are typically associated to lower payment transaction processing cost due to the elimination of the interchange between the selected acquiring bank 210 and the issuing bank 214 via the card association network 212. The need for such interchange typically leads to additional costs when the issuing bank 214 is different than the selected acquiring bank 210.

Now proceeding from the credit card payment transaction routing flow illustrated in FIG. 2 and the above observation, in one embodiment, the payment aggregator 208 incorporates a policy-based routing mechanism which addresses various aspects of payment transaction processing cost and efficiency, as will be further described below.

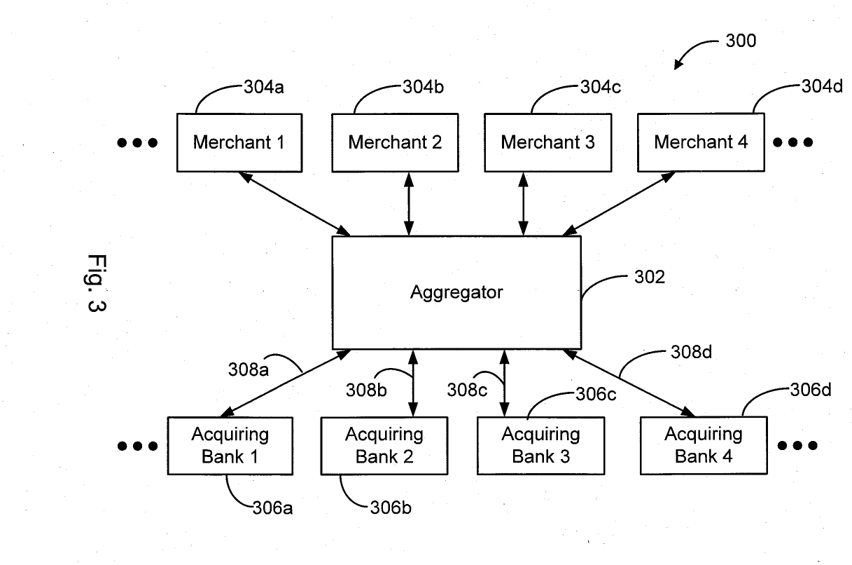

In reference to FIG. 3, the Payment Network Topology 300 has a payment aggregator 302 (similar to payment aggregator 208) routing payment transactions between multiple (N) merchants 304 such as merchants 304a, 304b, 304c, 304d (also referred to as merchant terminals), and multiple (N) acquiring banks 306 such as acquirers 306a, 306b, 306c, 306d (also referred to acquirers and/or their acquirer servers).

The payment aggregator 302 communicates with the multiple acquiring banks 306 via their corresponding payment channel 308a, 308b, 308c, 308d, etc. and integration technologies (i.e. the particular type of communication methods and technologies used by each acquirer: for example, leased line such as active private circuit lines, virtual private network (VPN) over Internet, specific messaging protocols and/or various application programming interfaces (APIs)). Merchants 304 also each communicate to the payment aggregator 302 for credit card payment transactions. Any communication network can be used to operatively connect the payment aggregator 302 to each one of the merchants and acquirers.

The payment aggregator 302 optimally routes payment requests to a given acquirer such as anyone of acquirers 306a, b, c or d within a pool of N acquirers. Optimal routing is performed, in one embodiment, to reduce overall transaction processing cost for a given merchant associated with terminals of merchants 304a, b, c or d. Other higher service levels can also be offered via the payment aggregator 302 in cases where such service levels are further supported by the multiple N acquirers 306. In addition or in an alternative, when the service of one acquirer 306a, b, c or d in the pool of N acquirers 306 is not available for example, payment processing can be dynamically routed or re-routed by the payment aggregator 302 to another available acquirer within the pool.

It is noted that although FIG. 3 illustrates a single Payment Aggregator environment in which a Next Payment Routing Hop corresponds to a payment acquirer (any one of 306a, b, c and d) that can process the payment request, there can be more than one level of payment aggregators. A topology having multiple interconnected Payment Aggregators each similar to the payment aggregator 302 is employed for example to deploy the routing service globally, with individual Payment Aggregators located in geographically dispersed locations. Such a topology is applicable to satisfy highly scalable design considerations for example. In a multiple Payment Aggregator topology, however, a next payment routing hop may be an acquirer or another Payment Aggregator available to respectively process or route the payment request accordingly.

In addition to the above, the payment network topology 300 as illustrated in FIG. 3 is usable, in one embodiment, to facilitate the establishment of relationships between merchants, their customers, and financial institutions. For example, the aggregator can be implemented to apply a pre-defined specific route such that all credit card transactions from a given merchant (or associated to a given merchant ID number) and involving a given card number range, for example, are always routed to a same acquiring bank; such as is the case in a default setting for example. The aggregator is also adaptable to enable merchants and banks to launch promotions, loyalty programs and marketing activities.

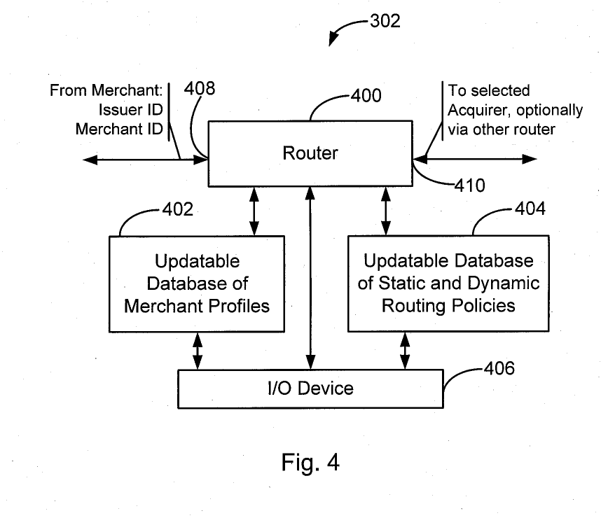

Now referring to FIG. 4, there is shown a detailed embodiment of the payment aggregator 302 of FIG. 3, having a router 400 (also referred to as a routing mechanism); an updatable database of merchant profiles 402; an updatable database of both static and dynamic routing policies 404; and multiple data input and output devices including an I/O device 406, as well as data ports 408 and 410 to the router 400.

In one embodiment, transaction routing policy (or policies) are used by the payment aggregator 302 to determine an optimal routing for a given incoming payment request to one of the acquiring banks 306a, b, c or d (refer to FIG. 3).

The incoming payment request received from a merchant includes a merchant identification (Merchant ID) and an issuer identification (Issuer ID) such as an IIN or BIN. In one embodiment, the issuer ID is provided by the first digits in the credit card number of the cardholding customer making a purchase from the merchant.

The payment aggregator 302 proceeds to determine an optimal routing, including a destination node being one of: another payment aggregator implemented as another intermediary payment processor for example, or an acquirer server of an acquiring bank (as illustrated by acquirers 306a, b, c and d in FIG. 3). In the case where more than one payment aggregator such as payment aggregator 302 is used along the entire path from merchant terminal to acquirer server, the second payment processor receiving the authorization request from the merchant terminal can be referred to as an intermediary processor. Such a topology is suitable in one embodiment where the routing is deployed over large geographical areas, across many countries using various currencies for example. In one embodiment, each payment processor such as aggregator 302 is deployed in a local area, optionally in operational communication with each other and with a centralized or zonal aggregator for example, via a communication network. In this way, optimal routes can be chosen based on costs of routing the transaction either between local aggregators, or via a national or international aggregator for example. Various types of interconnections between multiple aggregators, such as payment aggregator 302, are possible and within the scope of this description.

In one embodiment, the determination of the optimal routing is based on the following input information, from which a best available acquirer server is selected to route the incoming payment request:

(1) An identification of the issuing financial institution responsible for issuing the credit card involved in the payment transaction (and identified in the authorization request received from the merchant terminal). This identification can be what is commonly referred in the field as an Institution Identification Number (IIN), or a Bank Identification Number (BIN).

(2) An identification of the merchant which is to acquire a monetary amount once the payment transaction is completed. In one case, an Identification number (ID) is assigned to each merchant by the service provider of the payment aggregator 302.

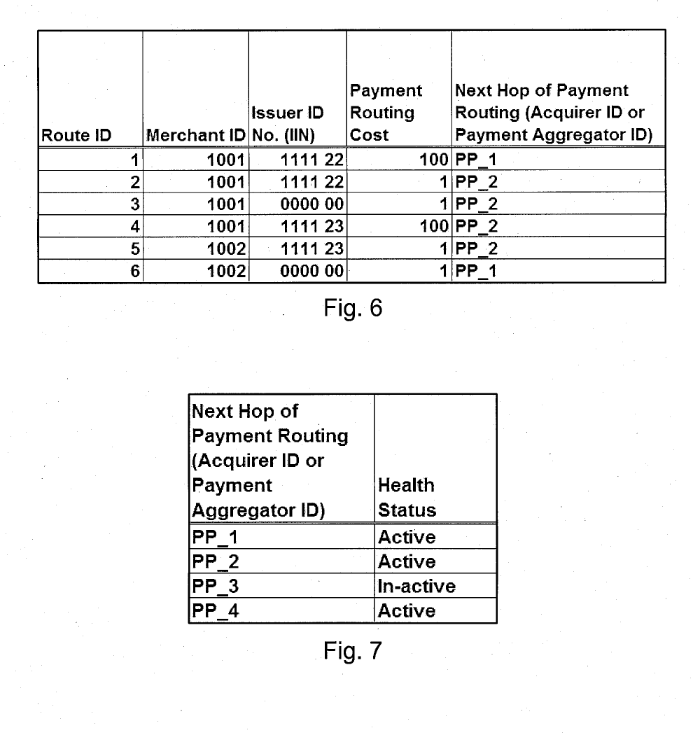

(3) Static Routing Policies: This policy defines the service support provided to the merchants by acquiring service providers. The database 404 stores merchant IDs with associated acquiring service providers (i.e. for example, a list of acquiring financial institutions where each of the merchants has an account and/or has access to the acquiring service offered by that acquiring financial institution, including details of the services provided). In one embodiment, this information is provided in the form of a routing table such as shown in FIG. 6, with identifications of various acquirer servers for each merchant identification number. FIG. 6 will be greater described below.

Still referring to FIG. 4, in one embodiment, the routing table is updated to define static priority levels each associated to an acquirer server. The priority levels are set in accordance with predefined transaction policies affecting payment processing costs for an initiating merchant. For example, when a given predefined policy currently in place by a given acquiring financial institution of the merchant provides a special discount rate in the case the transaction routing corresponds to an “On-Us” transaction routing (i.e. the acquiring bank is also the issuing bank for the card number in the transaction), this policy affects the payment processing cost.

Other policies can be taken into consideration and provided in the static routing policy table in order to allow the router 400 to determine an optimal routing for a given authentication request received from a given merchant.

Still in reference to FIG. 4, a fourth (4) item is also optionally used by the router 400 to determine an optimal route: Dynamic Routing Policies as stored and updated in real-time in the updatable database 404. Such dynamic information is used to ensure that the optimal route takes into consideration whether anyone or more of the acquirer servers isn't in service at a time of transaction. Various system problems and/or network connectivity which typically arise from time to time are thus accounted for. Dynamic information is updated with real-time availability status information received from each one of the acquirer servers in communication with the router 400. Status information can simply be an active/in-active flag which indicates that the acquirer server (or other intermediary payment processor) is either unavailable and/or inaccessible for payment processing at a given time.

In one embodiment, dynamic information is stored in a status table such as illustrated in FIG. 7, described in greater detail below.

Back to FIG. 4 and as an example, whenever the dynamic information indicates that a particular acquirer is unavailable, it is dynamically removed from the routing table and the router 400 automatically re-adjusts to accommodate the resulting change in availability of that acquirer server. Once the acquirer is available again, as per the dynamic updating of the status table in the database 404, the router 400 may automatically return to the original routing table.

A fifth (5) information item is used in one embodiment, by the router 400 to determine an optimal route: data stored in the database of Merchant Profiles 402. A merchant profile defines attributes of a merchant, including: a merchant identification (ID); identifications of supporting acquiring banks for that merchant, with their acquirer servers; a set of priority levels to be associated to the acquiring banks of that merchant based on applicable policies affecting payment transaction costs for that merchant (this information may be in database 404 instead or in addition); a geographical location of the merchant's terminals; currencies used by the merchant and supported by acquiring banks; and any payment transaction time-out parameters defining a given maximum amount of time the merchant is willing to allow for payment transactions. The merchant profiles can also include other merchant-related information. It is noted that data stored in the merchant profile is used, in one embodiment, to update routing tables.

Finally, still in reference to FIG. 4, the I/O device 406 allows a user and/or a client application, to enter data for updating the databases 402 and 404, or any of the routing mechanisms in the router 400. Similarly, routing tables, status tables acquirer information, merchant information and other information on given transactions can be displayed on the I/O device such as a display.

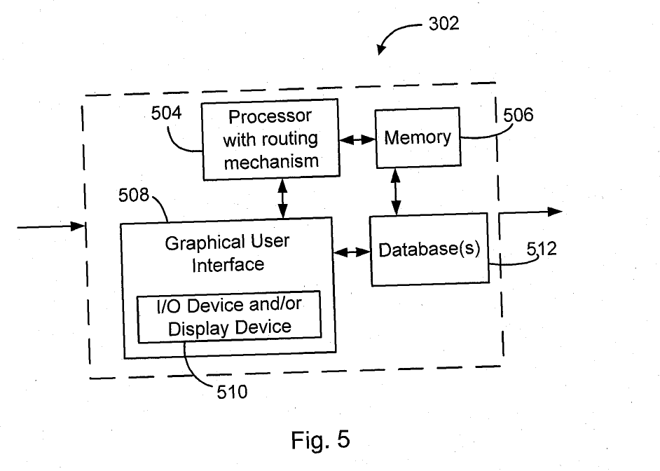

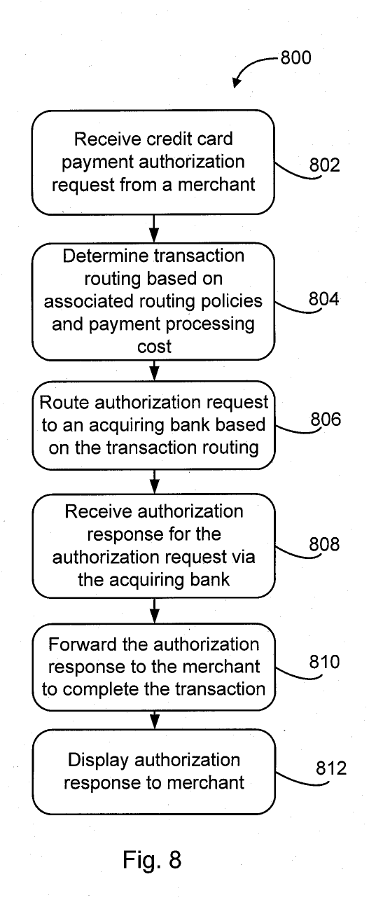

FIG. 5 illustrates another embodiment for the payment aggregator 302, in which a processor 504, in conjunction with the memory device 506, implements the router 400 of FIG. 4. The memory device stores instructions for implementing the processor to perform a series of steps which perform the routing of the credit card payment transaction in accordance with the present disclosure, and as later described below in reference to FIG. 8. The one or more database 512 stores other information such as the routing tables and merchant profiles described herein above. The graphical user interface (GUI) 508 and display device 510 provide the displaying of the routing tables and/or other routing confirmations and details, as well as the possibility to enter additional data.

FIG. 6 shows the payment routing table listing multiple different transaction routes (here 6) implementable by the aggregator described above. The payment routing cost is provided as a relative reference value for the cost of the routing a transaction request from a merchant with a merchant ID, to a next hop payment processor (right-most column). The Issuer identification number (IIN) identifies a final destination for the request to be processed (issuing bank).

In FIG. 6, route ID “3” with IIN “000000” is used here to specify a default route, such that when no specific IIN is provided, the authorization request is routed to payment processor “PP_{—}2”.

Still in the example of FIG. 6, the Issuing bank with IIN “111122” is also an acquiring bank of the merchant (Acquirer PP_{—}2), and thus an “On-Us” payment transaction takes place under route ID “2”. Since this is an “on-Us” transaction, the present example sets the payment routing cost to 1, as being a least cost indicator compared to other routes.

Now referring to FIG. 7, there is shown a status table which is dynamically maintained with real-time statuses of the Payment Processors involved in the different possible transaction routes. In the example of FIG. 7, the status of payment processor PP_{—}1, PP_{—}2 and PP_{—}4 are all active, while Payment Processor PP_3 is in-active. As such, a routing table associated with the table of FIG. 7 will exclude PP_{—}3 until it returns to an active state.

In case of a conflict in which multiple acquirers (transaction routes) have the same priority levels based on for example a same “payment routing cost” indicator, and both acquirers are available, a random “round robin” algorithm for example is used to select one of the acquirers as the optimal route. In case the selected acquirer fails to connect, the same algorithm is re-applied to select another acquirer.

Now in reference to FIG. 8, a method 800 of routing a credit card payment transaction over a communication network will be described.

In step 802, an authorization request for the credit card payment transaction is received at a payment processor. The authorization request is generated at a merchant terminal of a merchant.

In step 804, an optimal transaction route for sending the authorization request over the communication network to one of multiple acquirer servers, is determined at the payment processor. Each one of the multiple acquirer servers is associated to one of multiple acquiring financial institutions of the merchant, and the determining is based on the payment processing costs associated to the routing of the authorization request from the merchant terminal to each one of the multiple acquirer servers.

In step 806, the payment processor routes the authorization request to the one of the multiple acquirer servers implementing the optimal transaction route.

In step 808, the payment processor receives, from the one of the multiple acquirer servers, an authorization response for the authorization request.

In step 810, the payment processor forwards the authorization response to the merchant terminal.

In step 812, the merchant terminal can display the authorization response forwarded by the payment processor. This step ensures notification of the authorization response to a given user at the merchant terminal.

In one embodiment of the above step 802, the authorization response is generated in an issuing server of an issuing financial institution, the issuing server being adapted to process the authorization request and generate the authorization response, the one of the multiple acquirer servers forwarding the authorization response to the payment processor.

In the above, step 804 involves accessing a memory device comprising a database of routing policies applicable to multiple different transaction routes; and determining a priority level for each one of the multiple different transaction routes, based on information in the database of routing policies. Such information includes: transaction policies currently in place by the multiple acquiring financial institutions; an identification of the merchant terminal; and a particular credit card involved in the credit card payment transaction. In one embodiment, this information takes the form of a routing policy table with, for each one of the multiple different transaction routes: the identification of the merchant terminal; an Institution Identification Number (IIN) of an issuing financial institution for the particular credit card; a payment processing cost for that transaction route; and a next hop server in that transaction route. The next hop server can be any one of: an other payment processor acting as an intermediary point towards one of the multiple acquirer servers of the multiple acquiring financial institutions, and one of the multiple acquirer servers associated with that transaction route. Hence, the routing topology may involve multiple aggregators as those described above in relation to FIGS. 2 to 5.

Still in reference to FIG. 8, in one embodiment, step 804 involves determining a priority level for each one of the multiple different transaction real-time availability statuses associated to the multiple acquirer servers.

In such a case, the method 800 involves in one embodiment (not shown), the payment processor receiving an availability status from one or more of the multiple acquirer servers before or during the determining of the optimal transaction route in step 804; and updating the database of routing policies with the availability status received.

In addition to the above, in the case where more than one of the multiple different transaction routes are associated to a same priority level, the determining the optimal transaction route in step 804 involves in such case the applying of a random algorithm to the more than one of the multiple different transaction routes to obtain the optimal transaction route.

The above method 800 is adaptable to a case where there are multiple merchants involves, as well as multiple authorization requests received at step 802, the authorization requests being generated at multiple merchant terminals of multiple merchants.

In one embodiment, the determining an optimal route in step 804 involves retrieving a database of profiles of each one of the merchants from a memory device. The profiles provide an identification of one of the merchants, and one or more of the following information: more than one acquiring financial institution for the one of the merchants; a geographical location of the merchant terminal of the one of the merchants; a currency used by the one of the merchants; and a time-out parameter for payment transactions to be performed for the one of the merchants.

Any or all of the information stored in the database(s) accessed in the method 800 are further updatable with data entered via a data input device thereto.

The above detailed routing method and associated devices implement a transaction routing approach which provides flexibility for merchants to route payment transactions to multiple acquirers with virtually equal amounts of transactions for load distribution purposes and or relationship arrangements.

While preferred embodiments have been described above and illustrated in the accompanying drawings, it will be evident to those skilled in the art that modifications may be made therein without departing from the essence of this disclosure. Such modifications are considered as possible variants comprised in the scope of the disclosure.

1. A method for routing a credit card payment transaction over a communication network, the method comprising:
receiving an authorization request for the credit card payment transaction at a payment processor, the authorization request being generated at a merchant terminal of a merchant;
at the payment processor, determining an optimal transaction route for sending the authorization request over the communication network to one of multiple acquirer servers, each one of the multiple acquirer servers being associated to one of multiple acquiring financial institutions of the merchant, the determining being based on payment processing costs associated to routing the authorization request from the merchant terminal to each one of the multiple acquirer servers;
the payment processor routing the authorization request to the one of the multiple acquirer servers implementing the optimal transaction route;
the payment processor receiving, from the one of the multiple acquirer servers, an authorization response for the authorization request;
the payment processor forwarding the authorization response to the merchant terminal; and
the merchant terminal displaying the authorization response forwarded by the payment processor, to thereby notify a user of the authorization response.

2. The method of claim 1, wherein the payment processor receiving the authorization response comprises the payment processor receiving the authorization response generated at an issuing server of an issuing financial institution, the issuing server being adapted to process the authorization request and generate the authorization response, the one of the multiple acquirer servers forwarding the authorization response to the payment processor.

3. The method of claim 1, wherein the determining the optimal transaction route comprises accessing a memory device comprising a database of routing policies applicable to multiple different transaction routes.

4. The method of claim 3, wherein the determining the optimal transaction route comprises determining a priority level for each one of the multiple different transaction routes, based on information in the database of routing policies, the information comprising: transaction policies currently in place by the multiple acquiring financial institutions; an identification of the merchant terminal; and a particular credit card involved in the credit card payment transaction.

5. The method of claim 4, wherein the information in the database of routing policies comprises a routing policy table with, for each one of the multiple different transaction routes: the identification of the merchant terminal; an Institution Identification Number (IIN) of an issuing financial institution for the particular credit card; a payment processing cost for that transaction route; and a next hop server in that transaction route, the next hop server being one of: an other payment processor acting as an intermediary point towards one of the multiple acquirer servers of the multiple acquiring financial institutions, and one of the multiple acquirer servers associated with that transaction route.

6. The method of claim 3, wherein the determining the optimal transaction route comprises determining a priority level for each one of the multiple different transaction routes, based on information in the database of routing policies, the information comprising: a real-time availability status associated to at least one of the multiple acquirer servers.

7. The method of claim 6, comprising receiving, by the payment processor, the real-availability status from the at least one of the multiple acquirer servers before or during the determining of the optimal transaction route; and updating the database of routing policies with the real-availability status.

8. The method of claim 1, wherein the receiving the authorization request for the credit card payment transaction comprises receiving, at the payment processor, multiple authorization requests for multiple credit card payment transactions, the multiple authorization requests being respectively generated at multiple merchant terminals of multiple merchants.

9. The method of claim 8, wherein the determining an optimal route comprise retrieving a database of profiles of each one of the merchants from a memory device, each one of the profiles providing an identification of one of the merchants, and at least one of: more than one acquiring financial institution for the one of the merchants; a geographical location of the merchant terminal of the one of the merchants; a currency used by the one of the merchants; and a time-out parameter for payment transactions to be performed for the one of the merchants.

10. (canceled)

11. The method of claim 1, wherein when more than one of the multiple different transaction routes are associated to a same priority level, the determining the optimal transaction route comprises applying a random algorithm to the more than one of the multiple different transaction routes to obtain the optimal transaction route.

12. A processing device for routing a credit card payment transaction between a merchant terminal at a merchant, and acquirer servers each associated to one of multiple acquiring financial institutions of the merchant, the processing device comprising:
a processor in communication with: the merchant terminal, and each one of the acquirer servers of the multiple acquiring financial institutions; and
a memory device operatively coupled to the processor, the memory device storing instructions for implementing the processor to:
receive an authorization request for the credit card payment transaction from the merchant terminal;
determine an optimal transaction route for sending the authorization request to one of the acquirer servers, based on payment processing costs associated to routing the authorization request from the merchant terminal to each one of the acquirer servers;
route the authorization request to the one of the acquirer servers to implement the optimal transaction route;
receive, from the one of the acquirer servers, an authorization response for the authorization request; and
forward the authorization response to the merchant terminal, to thereby complete the credit card payment transaction using the optimal transaction route.

13. The processing device of claim 12, wherein the one of the acquirer servers receiving the authorization request is in operational communication with an issuing server of an issuing financial institution, the issuing server being adapted to process the authorization request and generate the authorization response; and wherein the one of the acquirer servers is further adapted to forward the authorization response to the processor.

14. The processing device of claim 12, wherein the memory device comprises a database of routing policies applicable to multiple different transaction routes; and wherein the processor, in determining the optimal transaction route, accesses the database of routing policies.

15. The processing device of claim 14, wherein the memory device comprises additional instructions for implementing the processor to determine a priority level for each one of the multiple different transaction routes, based on information in the database of routing policies, the information comprising: transaction policies currently in place by the multiple acquiring financial institutions; an identification of the merchant terminal; and a particular credit card involved in the credit card payment transaction.

16. The processing device of claim 15, wherein the database of routing policies comprises a routing policy table with, for each one of the multiple different transaction routes: an identification number of the merchant terminal; an Institution Identification Number (IIN) of an issuing financial institution for the particular credit card; and a next hop server for that transaction route, the next hop server being one of: an other processing device as an intermediary towards any one of the acquirer servers of the multiple acquiring financial institutions, and any one of the acquirer servers.

17. The processing device of claim 14, wherein the memory device comprises additional instructions for implementing the processor to determine a priority level for each one of the multiple different transaction routes, based on information in the database of routing policies, the information comprising: a real-time availability status associated to at least one of the acquirer servers.

18. The processing device of claim 17, wherein the memory device comprises additional instructions for implementing the processor to update, in real-time, the database of routing policies with the real-time availability status as received from the at least one of the acquirer servers.

19. (canceled)

20. The processing device of claim 17, wherein the memory device comprises a database of profiles of merchants each associated to at least one of the multiple merchant terminals, the profiles each identifying a merchant identification associated to one of the merchants, and at least one of: more than one acquiring financial institution for the one of the merchants; a geographical location of the merchant terminal; a currency used by the one of the merchants; and a time-out parameter for payment transactions to be performed for that one of the merchants.

21. (canceled)

22. The processing device of claim 12, wherein the processor and the memory device are implemented at the merchant terminal.

23. A computer readable media storing coding for implementing a routing of a credit card payment transaction in a processing device, the processing device having an access to a communication network, the coding implementing the processing device to:
receive, from a merchant, an authorization request for the credit card payment transaction;
determine an optimal transaction route for sending the authorization request over the communication network, to one of multiple acquirer servers, each one of the multiple acquirer servers being associated to one of multiple acquiring financial institutions of the merchant, the determining being based on payment processing costs associated to routing the authorization request from the merchant to each one of the multiple acquirer servers;
route the authorization request to the one of the multiple acquirer servers implementing the optimal transaction route;
receive, from the one of the multiple acquirer servers, an authorization response for the authorization request; and
display the authorization response at the merchant, to thereby notify the merchant of the authorization response.
